(19) United States
(12) Patent Application Publication
(10) Pub. No.: US 2026/0226649 A1
(43) Pub. Date: Aug. 6, 2026

(54) GENERAL PROCESS FOR ELECTROPOLISHING OF AM PARTS

(71) Applicant: Divergent Technologies, Inc., Los Angeles, CA (US)

(72) Inventors: Michael Thomas KENWORTHY, Rancho Palos Verdes, CA (US); Bahram ISSARI, Laguna Niguel, CA (US); Gordon TAJIRI, Los Angeles, CA (US); Matthew Steven GLEINER, Redondo Beach, CA (US)

(73) Assignee: Divergent Technologies, Inc., Los Angeles, CA (US)

(21) Appl. No.: 19/468,630

(22) Filed: Feb. 3, 2026

Related U.S. Application Data
(60) Provisional application No. 63/753,294, filed on Feb. 3, 2025.

(51) Int. Cl. C25F 3/16; B33Y 40/20

(52) U.S. Cl. CPC C25F 3/16; B33Y 40/20

(57) ABSTRACT

A method for electropolishing and electroplating surfaces of structures. The method includes inserting a flexible element into an internal volume of a structure, controlling the flexible element to move along an internal volume surface such that a nonconductive feature forms a gap between the internal volume surface and a flexible conductor, and energizing the flexible conductor such that a voltage is applied across the gap. The flexible element may include the flexible conductor and a nonconductive feature. The nonconductive feature may extend from the flexible conductor and may include a polymer, and/or a plurality of features. The features may include bristles or springs or hooks or rings or a combination thereof. The internal volume may include one or more channels, and controlling the flexible element may include manipulating the flexible element to move within any of the channels. The method may include providing a sheath offset from the flexible element.

### CROSS-REFERENCE TO RELATED APPLICATIONS

This application claims priority to U.S. Provisional Application No. 63/753, 294 entitled “GENERAL PROCESS FOR ELECTROPOLISHING OF AM PARTS” and filed on February 3, 2025, wherein the provisional application is expressly incorporated by reference herein in its entirety.

### BACKGROUND

### Field

The disclosure relates generally to a finishing process, and more specifically to electropolishing and electroplating internal surfaces of structures such as additive manufactured (AM) structures.

### Background

Three-dimensional (3-D) printing, also referred to as additive manufacturing (AM), has recently presented new opportunities to more efficiently build complex transport structures, such as structures and joined/assembled structures forming automobiles, aircraft, boats, motorcycles, buses, trains, gearboxes, semiconductors, and the like. AM techniques are capable of fabricating complex structures from various materials. Applying AM processes to industries that produce these structures has proven to produce a structurally more efficient transport structure. For example, an aircraft or automobile produced using 3-D printed structures may be made stronger, lighter, and consequently, more fuel efficient. Moreover, AM enables manufacturers to 3-D print structures that are more complex in shape and form and that are equipped with more advanced features and capabilities than structures made using traditional machining and casting techniques. For example, a 3-D printed structure may include complex internal volumes, passageways and channels and varying dimensional sections. The 3-D printed structures may be formed using layers of material based on a digital model data of the structure. A 3-D printer may form the structure defined by the digital model data by printing the structure one layer at a time or by other AM techniques.

3-D printing provides geometric and design flexibility that conventional manufacturing processes may not be able to obtain. For example, 3-D printing technologies can produce structures with very small feature sizes, and geometries that are either significantly difficult or impossible to produce using conventional manufacturing processes.

Manufacturers typically rely on different mass finishing techniques to achieve surface finishes on structures with a simple shape or on external surfaces of structures. Due to the complex internal shapes, volumes and passages of some structures including AM structures, there exists a need to finish the internal surfaces within these complex internal shaped and passage structures, which may form transport structures and other vehicle assemblies. Thus, this disclosure provides high quality surface finishes on internal surfaces within simple and complex internal shaped and passage structures. This disclosure also may be applied to provide high quality surface finishes on the external surfaces of these structures. Thus, this disclosure may be applied or used on any surface of any structure to achieve a high quality surface finish.

### SUMMARY

Several aspects of apparatuses, systems and methods for finishing internal surfaces of simple and complex structures (e.g., AM structures) will be described more fully hereinafter. Also, three-dimensional printing techniques of these structures will be described.

In one or more embodiments disclosed herein is a method including inserting a flexible element into an internal volume of a structure, controlling the flexible element to move along a surface of the internal volume such that a nonconductive feature forms a gap between the surface of the internal volume and a flexible conductor, and energizing the flexible conductor such that a voltage is applied across the gap. The flexible element may include the flexible conductor and the nonconductive feature. The nonconductive feature may extend from the flexible conductor. The nonconductive feature may additionally contact the inner surface of the structure.

In one or more embodiments, the surface of the internal volume may include one or more curved sections.

In one or more embodiments, controlling the flexible element may include moving the flexible element along the one or more curved sections of the surface of the internal volume.

In one or more embodiments, energizing the flexible conductor may include an electropolishing process or an electroplating/electrodeposition process.

In one or more embodiments, the flexible element may include a plurality of connected sections. Controlling the flexible element may include extending the plurality of connected sections along the surface of the internal volume.

In one or more embodiments, the flexible conductor may include a nonconductive material and an conductive wire. The conductive wire may be coupled to the nonconductive material.

In one or more embodiments, the nonconductive feature may include a polymer. Controlling the flexible element may include stimulating the polymer to move.

In one or more embodiments, the nonconductive feature may include a plurality of features. Extending the nonconductive feature from the flexible conductor may include stimulating the plurality of features.

In one or more embodiments, the nonconductive feature may include bristles or springs or rings or hooks or a combination of bristles, springs, hooks and rings, such that the gap is maintained when controlling the flexible element.

In one or more embodiments, the flexible conductor may include a wire. Controlling the flexible element may include moving the wire along the surface of the internal volume.

In one or more embodiments, the flexible element may include an end portion and a length portion. The end portion may be provided with a greater rigidity than the length portion.

In one or more embodiments, the internal volume may include a channel. Controlling the flexible element may include manipulating the flexible element such that the flexible element moves within the channel. The internal volume may also include additional channels and controlling the flexible element may include manipulating the flexible element to move within the channel and within any of the additional channels.

In one or more embodiments, one or more of the additional channels may include one or more curved sections and controlling the flexible element may include moving the flexible element along the one or more curved sections.

In one or more embodiments, any of the channels may include one or more curved sections and controlling the flexible element may include moving the flexible element along the one or more curved sections of the channel.

In one or more embodiments, the method may include providing a sheath offset from the flexible element. The sheath may include a plurality of apertures.

In one or more embodiments, the sheath may include a nonconducting material, such that an electrical connection between the sheath and the structure is not formed.

In one or more embodiments, the nonconductive feature may include a first set of features and a second set of features. The first set of features may extend from the flexible conductor. The second set of features may be provided between the sheath and the surface of the internal volume.

In one or more embodiments, the flexible conductor may include a wire and a polymer and controlling the flexible element may include stimulating the flexible conductor.

In one or more embodiments, stimulating the flexible conductor may include providing one or more electrical signals to the flexible conductor.

It will be understood that other aspects of structures, joining of structures and subcomponents, and methods and systems of finishing surfaces will become readily apparent to those skilled in the art from the following detailed description, wherein it is shown and described only several embodiments by way of illustration. As will be realized by those skilled in the art, the apparatuses, methods and systems for finishing surfaces are capable of other and different embodiments, and its several details are capable of modification in various other respects, all without departing from the invention. Accordingly, the drawings and detailed description are to be regarded as illustrative in nature and not as restrictive.

### BRIEF DESCRIPTION OF THE DRAWINGS

Various aspects of apparatuses, systems and methods for electropolishing and electroplating surfaces of structures such as internal and external surfaces of simple and complex structures (e.g., AM structures) will now be presented in the detailed description by way of example, and not by way of limitation, in the accompanying drawings, wherein:

FIGS. 1A-1D illustrate respective side views of a 3-D printer system in accordance with an aspect of the present disclosure.

FIG. 1E illustrates a functional block diagram of a 3-D printer system in accordance with an aspect of the present disclosure.

FIGS. 2 illustrates a cross-sectional view of an embodiment of an apparatus, system and process of performing a finishing process on one or more surfaces of an example structure in accordance with an aspect of the present disclosure.

FIG. 3 illustrates a cross-sectional view of an embodiment of an apparatus, system and process of performing a finishing process on one or more surfaces of an example structure in accordance with an aspect of the present disclosure and where a flexible element has moved to a different position within the example structure from the flexible elements' position shown in FIG. 2.

FIG. 4 illustrates an end view of a channel of an example structure showing the nonconductive feature including bristles.

FIG. 5 illustrates an end view of a channel of an example structure showing the nonconductive feature including springs.

FIG. 6 illustrates an end view of a channel of an example structure showing the nonconductive feature including hooks.

FIG. 7 illustrates an end view of a channel of an example structure showing the nonconductive feature including rings.

FIG. 8 illustrates a cross-sectional view of the nonconductive feature including moveable nonconductive features coupled to a flexible conductor.

FIG. 9 illustrates a side view of the nonconductive feature including a polymer and configured to be stimulated.

FIG. 10 illustrates a side view of the stimulated nonconductive feature/polymer.

FIG. 11 illustrates a side view of the flexible conductor including a polymer and configured to be stimulated.

FIG. 12 illustrates an embodiment of the flexible conductor including a nonconductive material and a conductive wire coupled to the flexible conductor.

FIG. 13 illustrates an embodiment of the flexible conductor including expandable sections.

FIG. 14 illustrates the expandable sections of the flexible conductor of FIG. 13 in an expanded position/state.

FIG. 15 illustrates a side view of the flexible conductive including a nonconductive coating and conductive brushes coupled to the flexible conductive.

FIG. 16 illustrates an end view of a channel of an example structure showing a sheath offset from the flexible conductor.

FIG. 17 illustrates a plurality of example structures having one or more of the flexible conductors placed/inserted therein.

FIG. 18 is a flowchart illustrating an example method in accordance with the apparatuses, systems and methods described herein.

### DETAILED DESCRIPTION

The detailed description set forth below in connection with the drawings is intended to provide a description of example embodiments of finishing internal surfaces of structures such as simple and complex shaped internal volumes and channels of the structures. For example, a flexible element may be manipulation and/or controlled to reach desired locations within the structure in order to enable the inner surfaces of the structure to be electropolished or electroplated. External surfaces of these structures may also be surface finished with the herein disclosed apparatuses, systems and methods. The structures may include AM structures or other manufactured structures. The structures may be structures that are to be joining together or the structures may be joined structures that form part of or form automobiles, aircraft, boats, motorcycles, buses, trains, gearboxes, semiconductors and their components, and the like. The structures, systems and methods are not intended to represent the only embodiments in which the disclosure may be practiced. The terms “exemplary” or "example" used throughout this disclosure means “serving as an example, instance, or illustration,” and should not necessarily be construed as preferred or advantageous over other embodiments presented in this disclosure. The detailed description includes specific details for the purpose of providing a thorough and complete disclosure that fully conveys the scope of the disclosure to those skilled in the art. However, the disclosure may be practiced without these specific details. In some instances, well-known structures and components may be shown in block diagram form, or omitted entirely, in order to avoid obscuring the various concepts presented throughout this disclosure.

### Additive Manufacturing

Additive Manufacturing (AM) involves the use of a stored geometrical model for accumulating layered materials on a build plate to produce a three-dimensional (3-D) build piece having features defined by the model. AM techniques are capable of printing simple and complex structures using a wide variety of materials. A 3-D structure may be fabricated based on a computer aided design (CAD) model. The CAD model can be used to generate a set of instructions or commands that are compatible with a particular 3-D printer. The AM process can create/manufacture a three-dimensional structure using the CAD model and print instructions. In the AM process, different materials or combinations of material, such as engineered plastics, thermoplastic elastomers, metals, ceramics, and/or alloys or combinations of the above, etc., may be used to create a three-dimensional structure.

The use of producing AM structures may provide significant flexibility and cost saving benefits. These, and other benefits may enable manufacturers of mechanical structures to produce the structures at a lower cost and in a more efficient manner. The techniques described in the present disclosure relate to a process for finishing surfaces of structures such as internal and external surfaces of AM structures, and/or other manufactured structures, and/or commercial off the shelf (COTS) structures. AM structures are 3-D structures that are printed by, for example, adding layer upon layer of one or more materials based on a preprogramed design. For example, the structure may be formed by a powder bed fusion (PBF) system/printer. The structures described herein may be structures used to assemble a variety of devices, such as engine components, structural components, etc. Further, such AM and/or COTS structures may be used in assemblies, such as vehicles, trucks, trains, motorcycles, boats, aircraft, and the like, or other mechanized assemblies, without departing from the scope of the present disclosure. Assembly of these structures may be performed robotically (e.g., by robots) or manually or a combinator of manual and robotic assembly.

### Structures and Terminology in AM

In an aspect of the present disclosure, a structure may be an example of an AM structure or a structure manufactured by other manufacturing methods. The structure may include structures joined together that form part of or form automobiles, aircraft, boats, motorcycles, buses, trains, gearboxes, semiconductors and their components, and the like. A structure may be any 3-D printed structure that includes features, such as an interface, for mating with another component. The structure may have internal or external features configured to accept a particular type of structure. Alternatively or additionally, the structure may be shaped to accept a particular type of structure. A structure may utilize any internal design or shape and accept any variety of structures without departing from the scope of the disclosure.

A structure interface may be configured to connect to an interface of another structure. For example, and not by way of limitation, an interface between structures may include a tongue-and-groove structure. The interface may include high precision features or complex geometries that allow them to perform specific functions, including creating connections to spanning structures such as tubes, structural panels, extrusions, sheet metal, and/or other structural members.

For clarity, structures may also include relatively simple connection features configured to connect with a more sophisticated network of connection features of the interface to form streamlined connections between structures. While these structures may incorporate more basic features, they advantageously may be 3-D printed at a higher print rate. Alternatively, structures may be built/manufactured using any 3-D print manufacturing or other manufacturing technology.

A number of different AM technologies may be well-suited for construction of structures in a transport structure or other mechanized assembly. Such 3-D printing techniques may include, for example, directed energy deposition (DED), selective laser melting (SLM), selective laser sintering (SLS), direct metal laser sintering (DMLS), electron beam melting (EBM), powder bed fusion (PBF), and/or other AM processes involving melting or fusion of metallic powders.

As in many 3-D printing techniques, these systems and processes (e.g., PBF systems and processes) can create build pieces (e.g., structures) layer-by-layer. Each layer or “slice” is formed by depositing a layer of powder and exposing portions of the powder to an energy beam. The energy beam is applied to melt areas of the powder layer that coincide with the cross-section of the build piece in the layer. The melted powder cools and fuses to form a slice of the build piece. The process can be repeated to form the next slice of the build piece, and so on. Each layer is deposited on top of the previous layer. The resulting structure is a build piece assembled slice-by-slice from the ground up. SLS and various other PBF techniques may be well suited to construction of gear cases and other transport structure components. However, it will be appreciated that other AM techniques, such as fused deposition modeling (FDM) and the like, are also possible for use in such applications.

While the disclosure relates primarily to finishing of complex internal volumes, channels and passageways of AM structures, the techniques described in his disclosure are not only applicable to internal volumes, channels and passageways. For instance, the techniques may be applied to external surfaces of structures as well. In addition, while the disclosure also describes finishing surfaces of AM structures using electropolishing and electroplating, any suitable technique for polishing a surface may be used without departing from the scope of the disclosure.

AM may include the manufacture of one or more structures. Using AM, a structure may be constructed to include additional features and functions, including interface functions, depending on the objectives.

A focus of the AM industry has been around printing geometries with good surface quality. However, it may be difficult to alter printing parameters to achieve geometries with good surface quality without having to print supports. Printing supports is non-ideal because the supports are difficult to remove and leave residual material on the surface which may be problematic for certain applications.

There are several mass finishing techniques that may be applied to achieve a high quality finish on simple objects or external surfaces. For example, a first mass finishing technique is electrochemical machining, which is a method of removing metal by an electrical chemical process. Electrochemical machining may be used for mass production and for working extremely hard materials or materials that are difficult to machine using conventional methods. In the electrochemical process, a negatively-charged (e.g., cathode) cutting tool is advanced into a positively charged (e.g., anode) workpiece such that a charge exchange takes place between the cathode and the anode in an aqueous electrolyte solution which targets specific areas of the workpiece. This can be used to create contours, ring ducts, grooves or bell hollows with no contact. The removed material may be precipitated from the electrolyte solution in the form of metal hydroxide. However, electrochemical machining requires specific tooling, which defeats the benefit of AM since AM may manufacture infinitely different geometric structures and creating a specific tool for each varied structure is cost prohibited.

Another mass finishing technique is abrasive flow machining, which flows an abrasive-laden fluid or a semi-solid abrasive-laden putty through or across parts to grind (e.g., finish) or remove a small quantity of material from a surface to be finished at very high temperatures. Abrasive flow machining may be useful when applied to workpieces containing passageways that are considered to be inaccessible with conventional deburring and polishing tools. However, equipment for abrasive flow machining is very expensive and features must be designed to adapt to the equipment. In addition, in abrasive flow machining techniques, each passageway has to be addressed independently, which may not be practical for structures with complex geometries.

Although these mass finishing techniques may be applied to objects with simple internal surfaces (e.g., one passage in a consistent size), these mass finishing techniques may not be viable for structures with multiple passages containing different sizes, different orientations and different trajectories. Moreover, these mass finishing techniques may include equipment and processes that exceed the cost of the structure, making these mass finishing techniques economically prohibited.

Accordingly, it would be useful to implement a general solution to the above mentioned issues by effectively and inexpensively polishing/plating/treating difficult to access inner surfaces of a structure. In addition, having a robust solution to clean up complex geometries of AM structures would allow mass printing of these structures with very difficult to finish geometries economical. Furthermore, the solution may also be used to clean up internal surfaces, which include multiple and complex passages and volumes.

The present disclosure is directed to finishing surfaces (e.g., internal and external surfaces) of simple and complex structures such as AM structures that may be assembled manually or robotically (e.g. by one or more robots) or a combination thereof to form a transport structure such as automobiles, aircraft, boats, motorcycles, buses, trains, gearboxes, semiconductors and their components, and the like. More specifically, the present disclosure describes a process of electropolishing and electroplating internal volumes and channels of structures such as complex and simple structures (e.g., AM structures). For example, to electropolish or electroplate internal surfaces of a structure, the disclosure includes inserting a flexible element into an internal volume of a structure, controlling the flexible element to move along a surface of the internal volume such that a nonconductive feature forms a gap between the internal volumes' surface and a flexible conductor, and energizing the flexible conductor such that a voltage is applied across the gap. The flexible element may include the flexible conductor and the nonconductive feature. The flexible conductor may extend from the flexible conductor. A processing media such as a fluid (e.g., a liquid, which may include a mixture of fluids) may be within the gap to enable electropolishing or electroplating. Having such a process prevents shorts (i.e., an electrical connection) between the flexible element and the surface (e.g., internal surface) of the structure and prevents variable gaps (i.e., having different gap dimensions) between the flexible element and the surface of the structure during the movement/operation/manipulation of the flexible element within the structure and the electropolishing or electroplating of the internal surface of the structure. Applying the voltage across the gap may be repeated multiple times until a desired finish is produced for all desired surfaces of the structure. Moreover, the process and system cost of finishing the structures' internal surfaces may be less expensive than the cost of the structure and thus, this disclosure provides an economically viable surface finishing process for large scale production of transport structures such as automobiles, aircraft, boats, motorcycles, buses, trains, gearboxes, semiconductors and their components, and the like.

### Additive Manufacturing Environment

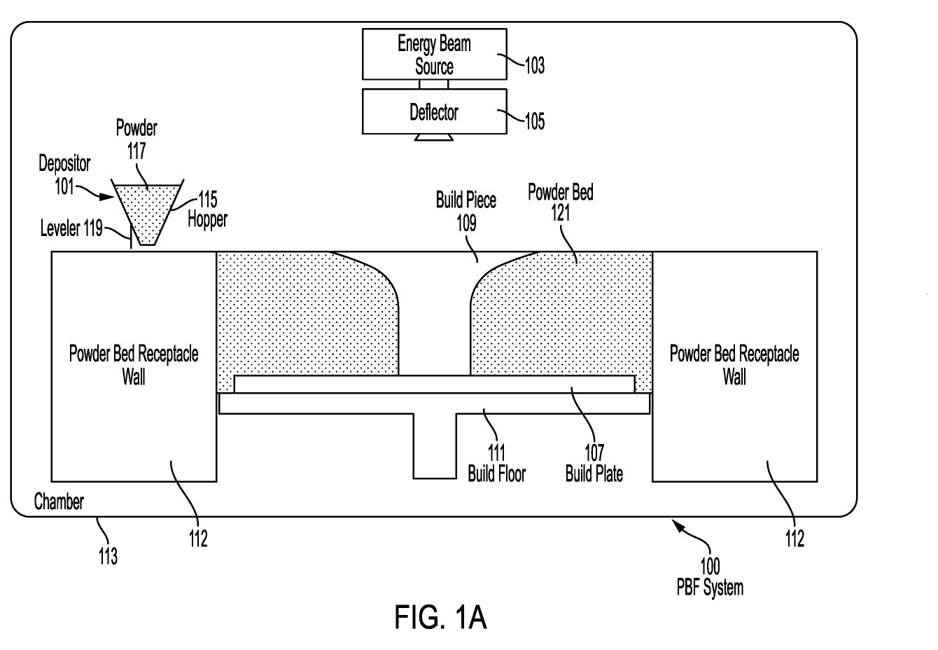

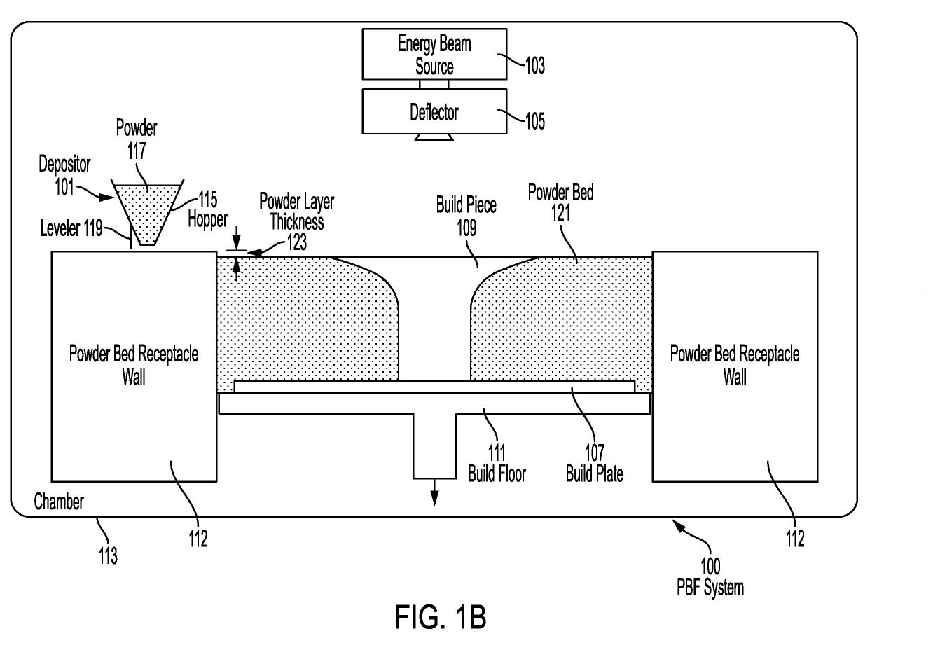

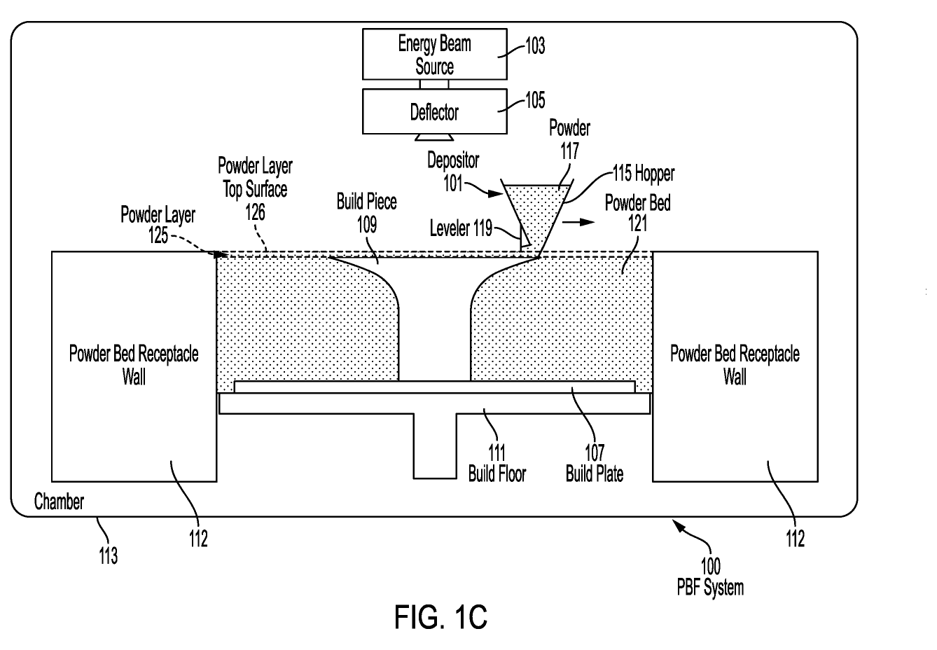

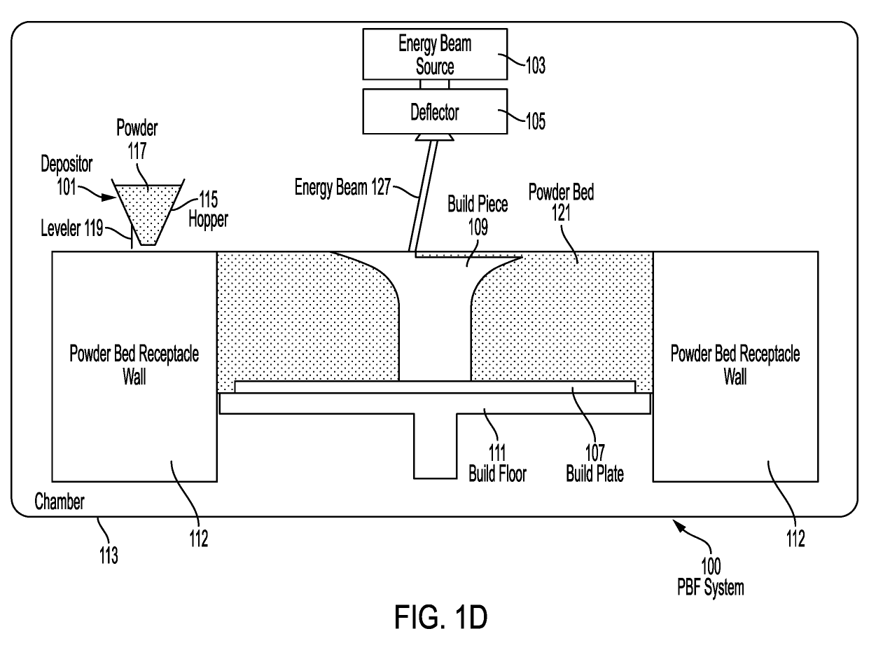

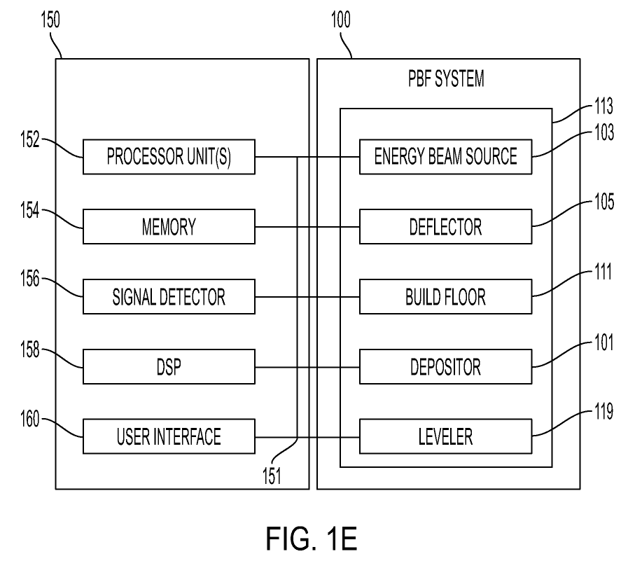

FIGS. 1A-1D illustrate respective side views of a 3-D printer system (e.g., a PBF system) in an aspect of the present disclosure.

In an aspect of the present disclosure, a 3-D printer system may be a powder-bed fusion (PBF) system 100. FIGS. 1A-D show PBF system 100 during different stages of operation. The particular embodiment illustrated in FIGS. 1A-1D is one of many suitable examples of a PBF system employing principles (e.g. creating and manufacturing one or more structures) of this disclosure. It should also be noted that elements of FIGS. 1A-1D and the other figures in this disclosure are not necessarily drawn to scale, but may be drawn larger or smaller for the purpose of better illustration of concepts described herein. PBF system 100 may include a depositor 101 that can deposit each layer 125 of powder 117 (e.g., metal powder), an energy beam source 103 that can generate an energy beam 127, a deflector 105 that can apply the energy beam to fuse the powder material, and a build plate 107 that can support one or more build pieces, such as a build piece 109. Although the terms “fuse” and/or “fusing” are used to describe the mechanical coupling of the powder particles, other mechanical actions, e.g., sintering, melting, and/or other electrical, mechanical, electromechanical, electrochemical, and/or chemical coupling methods are envisioned as being within the scope of the present disclosure.

PBF system 100 may also include a build floor 111 positioned within a powder bed receptacle. The walls 112 of the powder bed receptacle generally define the boundaries of the powder bed receptacle, which is sandwiched between the walls 112 from the side and abuts a portion of the build floor 111 below. Build floor 111 can progressively lower build plate 107 so that depositor 101 can deposit a next layer. The entire mechanism may reside in a chamber 113 that can enclose the other components, thereby protecting the equipment, enabling atmospheric and temperature regulation and mitigating contamination risks. Depositor 101 may include a hopper 115 that contains a powder 117, such as a metal powder, and a leveler 119 that can level the top of each layer of deposited powder.

Referring specifically to FIG. 1A, FIG. 1A illustrates PBF system 100 after a slice of build piece 109 has been fused, but before the next layer of powder has been deposited. In fact, FIG. 1A illustrates a time at which PBF system 100 has already deposited and fused slices in multiple layers, e.g., 200 individual layers, to form the current state of build piece 109, e.g., formed of 200 individual slices. The multiple individual layers already deposited have created a powder bed 121, which includes powder that was deposited but not fused.

FIG. 1B illustrates PBF system 100 at a stage in which build floor 111 can lower by a powder layer thickness 123. The lowering of build floor 111 causes build piece 109 and powder bed 121 to drop by powder layer thickness 123, so that the top of build piece 109 and powder bed 121 are lower than the top of powder bed receptacle wall 112 by an amount equal to the powder layer thickness 123. In this way, for example, a space with a consistent thickness equal to powder layer thickness 123 can be created over the tops of build piece 109 and powder bed 121.

FIG. 1C illustrates PBF system 100 at a stage in which depositor 101 is positioned to deposit powder 117 in a space created over the top surfaces of build piece 109 and powder bed 121 and bounded by powder bed receptacle walls 112. In this example, depositor 101 progressively moves over the defined space while releasing powder 117 from hopper 115. Leveler 119 can level the released powder to form a powder layer 125 that leaves powder layer top surface 126 configured to receive fusing energy from energy beam source 103. Powder layer 125 has a thickness substantially equal to the powder layer thickness 123 (see FIG. 1B). Thus, the powder in a PBF system can be supported by a powder material support structure, which may include, for example, a build plate 107, a build floor 111, a build piece 109, walls 112, and the like. It should be noted that the illustrated thickness of powder layer 125 (i.e., powder layer thickness 123 (FIG. 1B)) is greater than an actual thickness used for the example involving the 200 previously-deposited individual layers discussed above with reference to FIG. 1A.

FIG. 1D illustrates PBF system 100 at a stage in which, following the deposition of powder layer 125 (FIG. 1C), energy beam source 103 generates an energy beam 127 and deflector 105 applies the energy beam to fuse the next slice in build piece 109. In various embodiments, energy beam source 103 may be an electron beam source, in which case energy beam 127 constitutes an electron beam. Deflector 105 may include deflection plates that can generate an electric field or a magnetic field that selectively deflects the electron beam to cause the electron beam to scan across areas designated to be fused. In various embodiments, energy beam source 103 may be a laser, in which case energy beam 127 is a laser beam. Deflector 105 may include an optical system that uses reflection and/or refraction to manipulate the laser beam to scan selected areas to be fused.

In various embodiments, the deflector 105 may include one or more gimbals and actuators that can rotate and/or translate the energy beam source to position the energy beam. In various embodiments, energy beam source 103 and/or deflector 105 can modulate the energy beam, e.g., turn the energy beam on and off as the deflector scans so that the energy beam is applied only in the appropriate areas of the powder layer. For example, in various embodiments, the energy beam may be modulated by a digital signal processor (DSP).

FIG. 1E illustrates a functional block diagram of a 3-D printer system in accordance with an aspect of the present disclosure.

In an aspect of the present disclosure, control devices and/or elements, including computer software, may be coupled to PBF system 100 to control one or more components within PBF system 100. Such a control device may be a computer 150, which may include one or more components that may assist in the control of PBF system 100. Computer 150 may communicate with a PBF system 100, and/or other AM systems, via one or more interfaces 151. The computer 150 and/or interface 151 are examples of devices that may be configured to implement the various methods described herein, that may assist in controlling PBF system 100 and/or other AM systems.

In an aspect of the present disclosure, computer 150 may include one or more processor units 152, memory 154, a signal detector 156, a digital signal processor (DSP) 158, and one or more user interfaces 160. Computer 150 may include additional components without departing from the scope of the present disclosure.

The computer 150 may include one or more processor units 152, which may assist in the control and/or operation of PBF system 100. The processor unit 152 may also be referred to as a central processing unit (CPU). Memory 154, which may include both read-only memory (ROM) and random access memory (RAM), may provide instructions and/or data to the processor. A portion of the memory 154 may also include non-volatile random access memory (NVRAM). The processor 152 typically performs logical and arithmetic operations based on program instructions stored within the memory 154. The instructions in the memory 154 may be executable (by the processor unit 152, for example) to implement the methods described herein.

The processor unit 152 may comprise or be a component of a processing system implemented with one or more processors. The one or more processors may be implemented with any combination of general-purpose microprocessors, microcontrollers, digital signal processors (DSPs), floating point gate arrays (FPGAs), programmable logic devices (PLDs), controllers, state machines, gated logic, discrete hardware components, dedicated hardware finite state machines, or any other suitable entities that can perform calculations or other manipulations of information.

The processor unit 152 may also include machine-readable media for storing software. Software shall be construed broadly to mean any type of instructions, whether referred to as software, firmware, middleware, microcode, hardware description language, or otherwise. Instructions may include code (e.g., in source code format, binary code format, executable code format, RS-274 instructions (G-code), numerical control (NC) programming language, and/or any other suitable format of code). The instructions, when executed by the one or more processors, cause the processing system to perform the various functions described herein.

The computer 150 may also include a signal detector 156 that may be used to detect and quantify any level of signals received by the computer 150 for use by the processing unit 152 and/or other components of the computer 150. The signal detector 156 may detect such signals as energy beam source 103 power, deflector 105 position, build floor 111 height, amount of powder 117 remaining in depositor 101, leveler 119 position, and other signals. Signal detector 156, in addition to or instead of processor unit 152 may also control other components as described with respect to the present disclosure. The computer 150 may also include a DSP 158 for use in processing signals received by the computer 150. The DSP 158 may be configured to generate instructions and/or packets of instructions for transmission to PBF system 100.

The computer 150 may further comprise a user interface 160 in some aspects. The user interface 160 may include a keypad, a pointing device, and/or a display. The user interface 160 may include any element or component that conveys information to a user of the computer 150 and/or receives input from the user.

The various components of the computer 150 may be coupled together by a bus system 151. The bus system 151 may include a data bus, for example, as well as a power bus, a control signal bus, and a status signal bus in addition to the data bus. Components of the computer 150 may be coupled together or accept or provide inputs to each other using some other mechanism.

Although a number of separate components are illustrated in FIG. 1E, one or more of the components may be combined or commonly implemented. For example, the processor unit 152 may be used to implement not only the functionality described above with respect to the processor unit 152, but also to implement the functionality described above with respect to the signal detector 156, the DSP 158, and/or the user interface 160. Further, each of the components illustrated in FIG. 1E may be implemented using a plurality of separate elements.

By way of example, an element, or any portion of an element, or any combination of elements may be implemented using one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors may execute software as described above.

In one or more aspects, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, compact disc (CD) ROM (CD-ROM) or other optical disk storage, magnetic disk storage or other magnetic storage devices, or any other medium that can be used to carry or store desired program code in the form of instructions or data structures and that can be accessed by a computer. Disk and disc, as used herein, includes CD, laser disc, optical disc, digital versatile disc (DVD), floppy disk and Blu-ray disc where disks usually reproduce data magnetically, while discs reproduce data optically with lasers. Thus, computer readable medium includes a non-transitory computer readable medium (e.g., tangible media).

### Apparatus, System and Finishing Process

Throughout this entire disclosure, the terms conductive, conductivity, nonconductive, nonconductivity refers to electrically conductive/nonconductive unless otherwise stated.

The disclosure provides example apparatuses, systems and processes for performing a finishing process on the internal surfaces of a structure. Electropolishing and electroplating may be the finishing process on the internal surfaces of the structure. Also, the structures' external surfaces may be electropolished and electroplated by any of the disclosed embodiments here within. The internal surfaces of the structure may include the internal surfaces of any volume within the structure and the structure may be an AM structure or any type of manufactured structure. In one or more embodiments, the structure may include an internal volume and an inner surface. The internal volume may include any geometric shape including simple and complex shapes. For example, the internal volume may have different sizes, shapes and orientations, and/or trajectories from what is illustrated in the example structures and may make the internal volume difficult to clean. In one or more embodiments, the structure may include one or more internal volumes and/or one or more channels. For example, the structure may include one or more internal volumes and each internal volume may include one or more channels. Additionally or alternatively, the structure may include one or more channels. More details of the features and processes of electropolishing and electroplating will be described below.

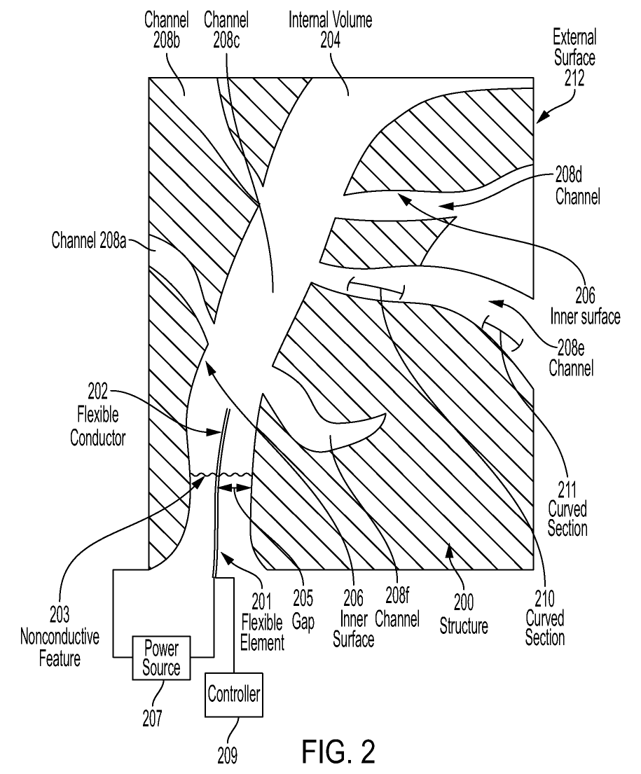

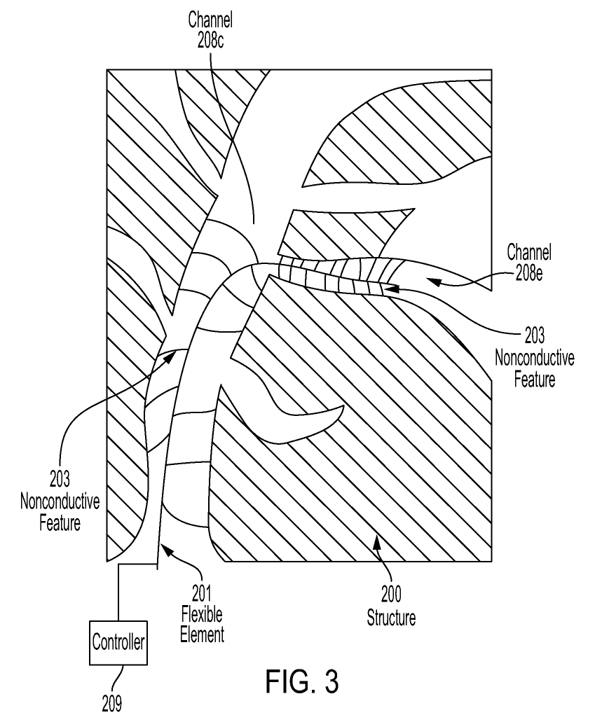

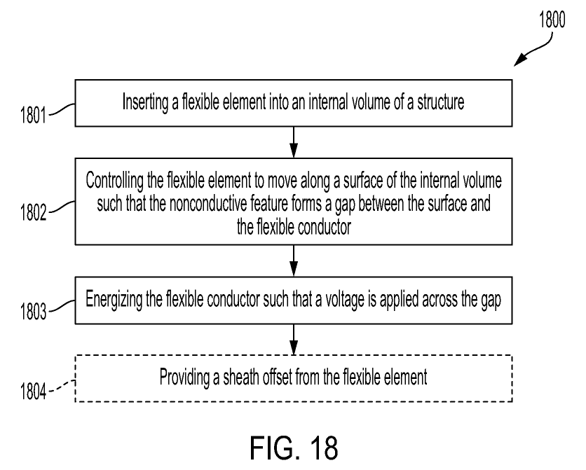

FIG. 2 illustrates an example apparatus and system for and a method of performing electropolishing or electroplating surfaces of a structure. FIG. 2 illustrates an example of a structure 200 that may have its internal surfaces and/or external surfaces electropolished or electroplated. The structure 200 may include an external surface 212, an internal volume 204, inner surfaces 206, and internal channels 208a,208b,208c,208d,208e,208f(i.e.,208a-f). Channel 208e may include two curved sections 210,211. In one or more embodiments, a flexible element can be placed/inserted within an internal volume, such as described by the process illustrated in FIG. 18. FIG. 2 also illustrates a flexible element 201 placed/inserted within an internal volume, where the internal volume may include one or more of the channels, for example channel 208c. The flexible element 201 may include a flexible conductor 202 and a nonconductive feature 203. The nonconductive feature spaces the flexible conductor away from the inner surface of the structure thus, forming a gap (e.g., gap 205) between the flexible conductor and the inner surface of the structure, and prevents the flexible conductor from contacting the inner surface of the structure. FIG. 2 illustrates only one nonconductive feature. However, the nonconductive feature may include a plurality of nonconductive features as shown in at least FIG. 3. In one or more embodiments, the flexible element can be controlled and/or moved through the internal volume and/or channels of the structure, such as described by the process illustrated in FIG. 18. A controller 209 may be coupled to the flexible element (e.g., the flexible conductor) to control and/or move the flexible element through the internal volume and/or channels of the structure. For example, the controller may include manipulating the flexible element such that the flexible element moves (e.g., moves forward, backward, left, right, up, down or spins) within the internal volume and the channel of the structure. Also, the controller may include manipulating the flexible element such that the flexible element changes directions (e.g., moves forward, backward, left, right, up, down or spins) such that the flexible element is controlled to enter into any desired volume and channel within the structure. The controller may include a manual controller, a mechanical controller, a electromechanical controller, a pneumatic controller, an electrical controller or a combination thereof. In one or more embodiments, the controller may include a person or a robot forcing the flexible conductor through the internal volume and/or channel. Forcing the flexible conductor may include twisting, pushing, pulling, or a combination thereon to move and manipulate the flexible element into a desired volume and/or channel. Also, forcing the flexible conductor may include providing a left, right, up, down or rotational force to the flexible conductor to move and manipulate the flexible element into a desired volume and/or channel. In one or more embodiments, the controller may send electrical signals to the flexible element and/or the flexible conductor to control and manipulate the movement of the flexible element and/or the flexible conductor. In one or more embodiments, energizing the flexible element such that a voltage is applied across the gap is also described by the process illustrated in FIG. 18. FIG. 2 also illustrates a power source 207 coupled to the flexible element (e.g., the flexible conductor) and to the structure. In one or more embodiments, the power source energizes the flexible conductor and provides an electric potential difference between the flexible element/conductor and the structure such that a voltage is applied across the gap. A processing media such as a fluid (e.g., a liquid, which may include a mixture of fluids) may be inserted/flowed within at least the gap for an electropolishing process and an electroplating process. For example, to electropolish the internal/inner surface(s) of the structure, the power source creates a potential difference between the flexible element/conductor and the structure such that the flexible conductor functions as a cathode and the structure functions as an anode, thus applying a voltage across the gap. Thus, the electropolishing process includes the structure functioning as the anode and the flexible conductor functioning as the cathode and after placing/inserting a desired electrolyte/fluid within the structure, and application of electricity/voltage, material will be removed from the internal surface of the structure forming a smooth internal surface for example, a mean roughness surface finish less than 10 microns. If the internal surface(s) of the structure is to be electroplated, then the power source creates a potential difference between the flexible element/conductor and the structure such that the flexible conductor functions as an anode and the structure functions as an cathode, thus applying a voltage across the gap. Thus, electroplating/electrodepositing can be thought of as a reverse process of the electropolishing process because in the electrodepositing process the anode includes the flexible conductor and the cathode includes the structure and after placing/inserting a desired electrolyte/fluid within the structure, and application of electricity/voltage, the anode will deposit ions onto the internal surface of the structure, which is acting as the cathode. In one or more embodiments, the fluid may flow within the gap and/or one or more channels and/or one or more internal volumes via a pump. In one or more embodiments, the fluid may be inserted within the gap and/or one or more channels and/or one or more internal volumes by placing/inserting the structure within a container filled with the fluid such that the structure is partially or fully immersed within the fluid.

Because the structures within the disclosure are examples of a few illustrated structures, the structures may include more or less features than illustrated. Thus, any of the channels 208a-f may include one or more curved sections or one or more linear sections or a combination of one or more curved sections and one or more liner sections. Two of the channels (i.e., 208c,208e) in FIG. 2 may have their first and second ends fluidly communicating with the external surface of the structure. However, the number of channels having both of its ends fluidly communicating with the external surface of the structure may be more or less than the number illustrated in FIG. 2. Four of the channels (i.e., 208a,208b,208d,208f) in FIG. 2 may have an end that does not fluidly communicate with the external surface of the structure. However, the number of channels having an end not fluidly communicating with the external surface of the structure may be more or less than the number illustrated in FIG. 2. One channel (i.e., 208f) may have a first end in fluid communication with another channel and may have a second end not in fluid communication with the external surface of the structure nor in fluid communication with the any other channel. However, the number of channels having a first end in fluid communication with another channel and having a second end not in fluid communication with the external surface of the structure nor in fluid communication with the any other channel may be more than the number illustrated in FIG. 2 or in any other figure. Moreover, the internal volume may include one or more channels. The internal volume and channels may include any geometric shape including simple and complex shapes. For example, the internal volume and the channels may have different sizes, shapes and orientations, and/or trajectories from what is illustrated in the example structure shown in FIG. 2 or in any other figure and may make the internal volume and channels difficult to clean. In one or more embodiments, the structure may include a plurality of internal volumes and each internal volume may include one or more channels. Also, the structure may include more or less channels than illustrated in FIG. 2 or in any other figure. The internal volume and channels may be configured to provide for the electropolishing process or the electroplating process.

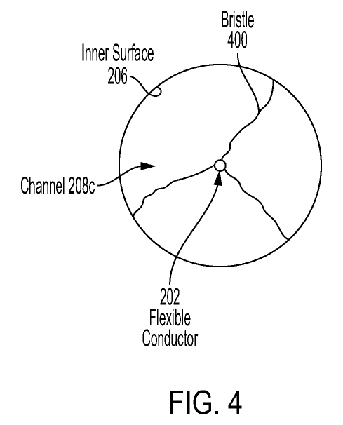

FIG. 3 illustrates flexible element 201 in a different position (i.e., the flexible element has moved) that the flexible elements' position within the structure 200 as shown in FIG. 2. FIG. 3 illustrates the flexible element 201 having been moved through the channel 208c and controlled/manipulated to enter into and move through the channel 208e of the structure 200. For example, the controller 209 may manually, robotically (i.e., using a robot), mechanical, electromechanical or any combination thereof move the flexible element through a channel (e.g., channel 208c) and may manipulated the flexible element to enter into another channel (e.g., channel 208e) and through at least a portion of the another channel to perform electropolishing or electroplating of the inner surfaces of the structure. FIG. 3 also illustrates nonconductive feature including a plurality of nonconductive features 203. The controller may move and manipulate the flexible element to move through and enter into any internal volume and channel within the structure to perform electropolishing or electroplating of the inner surfaces of the structure. The number of nonconductive features may be more or less than the number illustrated in FIG. 3. Also, the one or more of the nonconductive features may be flexible such that the nonconductive features may bend/flex due to contacting the inner surface of the structure when moving through the one or more internal volumes and channels of the structure. More details of the nonconductive features are provided within FIGS. 4-10.

FIG. 4 illustrates the nonconductive features being bristles 400. FIG. 4 illustrates three bristles. The bristles may be formed from a material that forms and maintains a gap between the inner surface of the structure and the flexible conductor. The bristles may be formed from a material that prevents the flexible conductor from contacting the inner surface of the structure. In one or more embodiments, the bristles may be a nonelectrically conducting and nonthermally conducting material. For example, the bristles may include plastics or polymers or ceramics or wood or fiberglass or other known or equivalent nonelectrically conductive material. In one or more embodiments, the bristles may be a metal or an alloy coated with a nonelectrically conducting material. In one or more embodiments, the bristles may be flexible such that the bristles may bend/flex due to contacting the inner surface of the structure when moving through the one or more internal volumes and channels of the structure. The bristles spacing on the flexible conductor, flexibility (e.g., modulus of elasticity), length, direction from the structures' inner surface, distance therebetween, and number may be designed to maximize the ease of placing the flexible element/conductor within the structure, provide the most desired gap distance, have a least obstruction to the processing media/fluid flow between the cathode and anode, and provide for superior electropolishing or electroplating results such as a Ra (mean roughness) surface finish less than 10 microns.

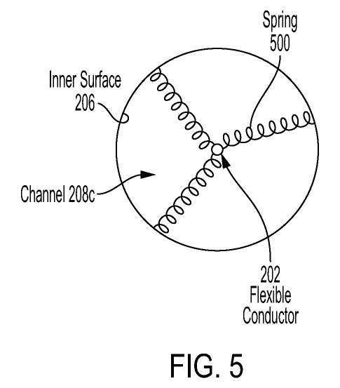

FIG. 5 illustrates the nonconductive features being springs 500. FIG. 5 illustrates three springs. The springs may be formed from a material that forms and maintains a gap between the inner surface of the structure and the flexible conductor. The springs may be formed from a material that prevents the flexible conductor from contacting the inner surface of the structure. In one or more embodiments, the springs may be a nonelectrically conducting and nonthermally conducting material. For example, the springs may include plastics or polymers or ceramics or wood or fiberglass or other known or equivalent nonelectrically conductive material. In one or more embodiments, the springs may be a metal or an alloy coated with a nonelectrically conducting material. In one or more embodiments, the springs may be flexible such that the springs may bend/flex due to contacting the inner surface of the structure when moving through the one or more internal volumes and channels of the structure. The springs spacing on the flexible conductor, flexibility (e.g., modulus of elasticity), length, direction from the structures' inner surface, distance therebetween, and number may be designed to maximize the ease of placing the flexible element/conductor within the structure, provide the most desired gap distance, have a least obstruction to the processing media/fluid flow between the cathode and anode, and provide for superior electropolishing or electroplating results such as a Ra (mean roughness) surface finish less than 10 microns.

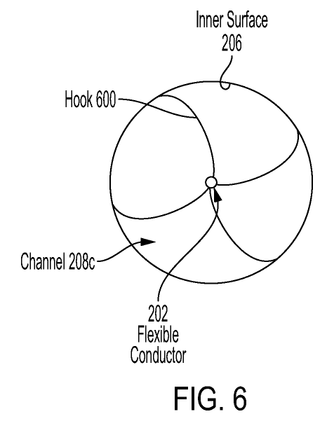

FIG. 6 illustrates the nonconductive features being hooks 600. The hooks may include one or more curved portions and/or one or more linear portions. For example, the hooks may include a semi-circular shape or any other geometric shape with a curved potion at one end. FIG. 6 illustrates four hooks. The hooks may be formed from a material that forms and maintains a gap between the inner surface of the structure and the flexible conductor. The hooks may be formed from a material that prevents the flexible conductor from contacting the inner surface of the structure. In one or more embodiments, the hooks may be a nonelectrically conducting and nonthermally conducting material. For example, the hooks may include plastics or polymers or ceramics or wood or fiberglass or other known or equivalent nonelectrically conductive material. In one or more embodiments, the hooks may be a metal or an alloy coated with a nonelectrically conducting material. In one or more embodiments, the hooks may be flexible such that the hooks may bend/flex due to contacting the inner surface of the structure when moving through the one or more internal volumes and channels of the structure. The hooks spacing on the flexible conductor, flexibility (e.g., modulus of elasticity), length, direction from the structures' inner surface, distance therebetween, and number may be designed to maximize the ease of placing the flexible element/conductor within the structure, provide the most desired gap distance, have a least obstruction to the processing media/fluid flow between the cathode and anode, and provide for superior electropolishing or electroplating results such as a Ra (mean roughness) surface finish less than 10 microns.

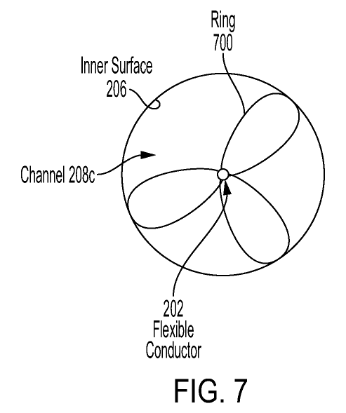

FIG. 7 illustrates the nonconductive features being rings. The rings may be in a shape of a closed ring. For example, the rings may include an oval shape or circular shape or any other geometric shape. FIG. 7 illustrates three closed rings. The rings may be formed from a material that forms and maintains a gap between the inner surface of the structure and the flexible conductor. The rings may be formed from a material that prevents the flexible conductor from contacting the inner surface of the structure. In one or more embodiments, the rings may be a nonelectrically conducting and nonthermally conducting material. For example, the rings may include plastics or polymers or ceramics or wood or fiberglass or other known or equivalent nonelectrically conductive material. In one or more embodiments, the rings may be a metal or an alloy coated with a nonelectrically conducting material. In one or more embodiments, the rings may be flexible such that the rings may bend/flex due to contacting the inner surface of the structure when moving through the one or more internal volumes and channels of the structure. The rings spacing on the flexible conductor, flexibility (e.g., modulus of elasticity), length, direction from the structures' inner surface, distance therebetween, and number may be designed to maximize the ease of placing the flexible element/conductor within the structure, provide the most desired gap distance, have a least obstruction to the processing media/fluid flow between the cathode and anode, and provide for superior electropolishing or electroplating results such as a Ra (mean roughness) surface finish less than 10 microns.

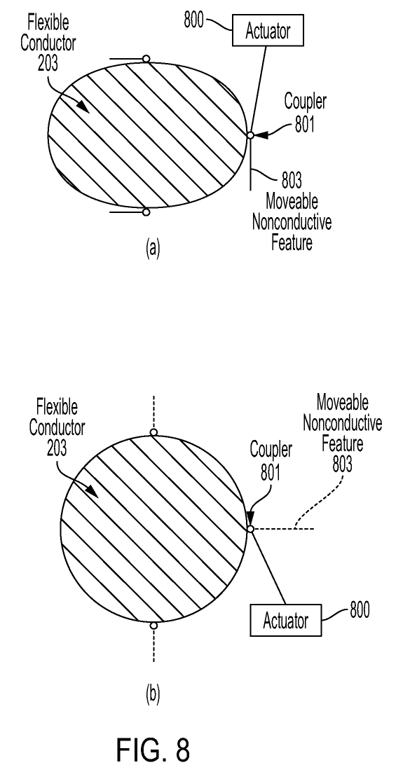

FIG. 8 illustrates the nonconductive features being moveable nonconductive features 803. Each moveable nonconductive feature may be coupled via a coupler 801 to the flexible conductor 203. An actuator 800 may contact the moveable nonconductive feature(s) and/or the coupler(s) in order to move/actuate the moveable nonconductive features as will be explained below. The actuator may include a manual actuator, a mechanical actuator, a electromechanical actuator, a pneumatic actuator, an electrical actuator or a combination thereof. In one or more embodiments, the couplers may include a movable joint fastened between the moveable nonconductive features and the flexible conductor. The joint may be fastened between the moveable nonconductive features and the flexible conductor with fasteners such as an adhesive or screws or nuts and bolts or rivets or a combination thereof or any other known fastener or fastener apparatus or system. In one or more embodiments, the couplers may be embedded within the flexible conductor. For example, a recess may be included within the flexible conductor such that the coupler fixes/embeds the moveable nonconductive feature within the recess. In one or more embodiments, the couplers may be any mechanism, which enables movement of the moveable nonconductive feature. Each of the views (i.e., views (a) and (b)) illustrate three moveable nonconductive features. View (a) in FIG. 8 illustrates the moveable nonconductive features in a state prior to the moveable nonconductive features being actuated by the actuator and view (b) in FIG. 8 illustrates the moveable nonconductive features (shown in dashed lines) having been moved/actuated by the actuator to form the gap between the inner surface of the structure and the flexible conductor. For example, the actuator provides motion/movement to the moveable nonconductive features and/or the couplers such that when the flexible conductor has been placed/manipulated within the internal volume and/or one or more channels within the structure, the moved/actuated moveable nonconductive features form the gap between the inner surface of the structure and the flexible conductor. The actuator may be an apparatus that supplies a force and/or a torque to the moveable nonconductive features and/or the couplers when supplied with a mechanical, electrical, pneumatic or combination thereof energy/input in order to move the moveable nonconductive features to a desired position such that a desired gap is formed between the inner surface of the structure and the flexible conductor. The moveable nonconductive features 803 may be formed from a material that forms and maintains a gap between the inner surface of the structure and the flexible conductor. The moveable nonconductive features may be formed from a material that prevents the flexible conductor from contacting the inner surface of the structure. In one or more embodiments, the moveable nonconductive features may be a nonelectrically conducting and nonthermally conducting material. For example, the moveable nonconductive features may include plastics or polymers or ceramics or wood or fiberglass or other known or equivalent nonelectrically conductive material. In one or more embodiments, the moveable nonconductive features may be a metal or an alloy coated with a nonelectrically conducting material. In one or more embodiments, the moveable nonconductive features may be flexible such that the moveable nonconductive features may bend/flex due to contacting the inner surface of the structure when moving through the one or more internal volumes and channels of the structure. The moveable nonconductive features spacing on the flexible conductor, flexibility (e.g., modulus of elasticity), length, direction from the structures' inner surface, distance therebetween, and number may be designed to maximize the ease of placing the flexible element/conductor within the structure, provide the most desired gap distance, have a least obstruction to the processing media/fluid flow between the cathode and anode, and provide for superior electropolishing or electroplating results such as a Ra (mean roughness) surface finish less than 10 microns.

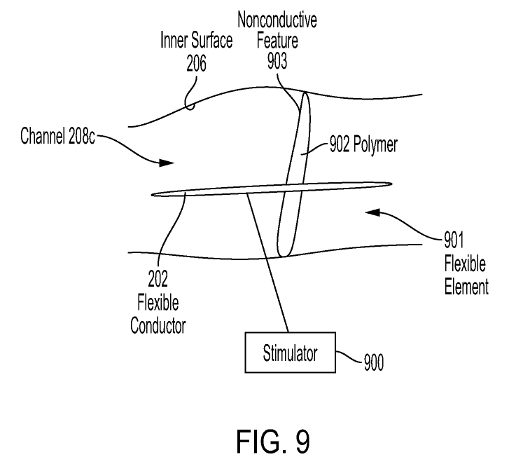

Similar to the flexible element illustrated in FIGS. 2 and 3, FIG. 9 illustrates a flexible element including a flexible conductor and a nonconductive feature. More specifically, FIG. 9 illustrates a flexible element 901 including a flexible conductor 202 and a nonconductive feature 903, where the nonconductive feature includes a polymer 902. The polymer may be coupled to a stimulator 900 and to the flexible conductor. In one or more embodiments, the polymer may include electrically sensitive polymers or thermally sensitive polymers such that the polymer moves and/or changes shape due to electrical, magnetic or thermal stimulation by the stimulator. For example, a stimulator may apply an electrical charge to the flexible conductor and because the electrically sensitive polymer is couped to the flexible conductor, the electric charge is transferred to the electrically sensitive polymer such that the electrically sensitive polymer changes its shape and/or moves in a manner such that the nonconductive feature, which includes the electrically sensitive polymer moves along the channels of the structure. Because the polymer moves and/or changes shape, the forces generated by this movement against the inner surfaces of the structure cause the flexible conductor and thus, the flexible element to move along the channel. In one or more embodiments, the polymer may include a feature such that the polymer moves and/or changes shape. For example, the polymers' feature may include embedded metal particles, where a magnetic field generated by the simulator of other device may make the polymer move and/or change shape. In another example, the polymers' feature may include one or more fluid channels within the polymer such that the stimulator or other device such as a pump may be in fluid communication with the one or more fluid channels such that the fluid is forced into the one or more fluid channels to make the polymer move and/or change shape. FIG. 9 illustrates only one nonconductive feature however, a plurality of nonconductive features may be coupled to the flexible conductor, thus a plurality a polymers may be coupled to the flexible conductor.

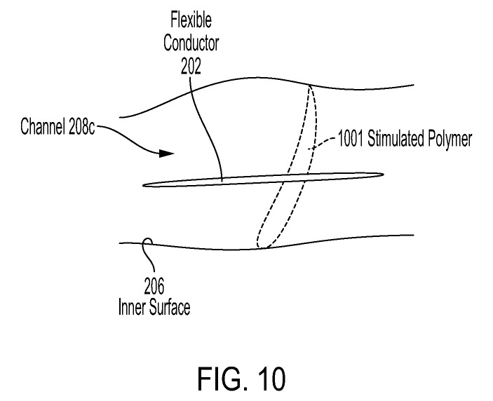

FIG. 10 illustrates the polymer of FIG. 9 having been stimulated by the stimulator in dashed lines as stimulated polymer 1001.

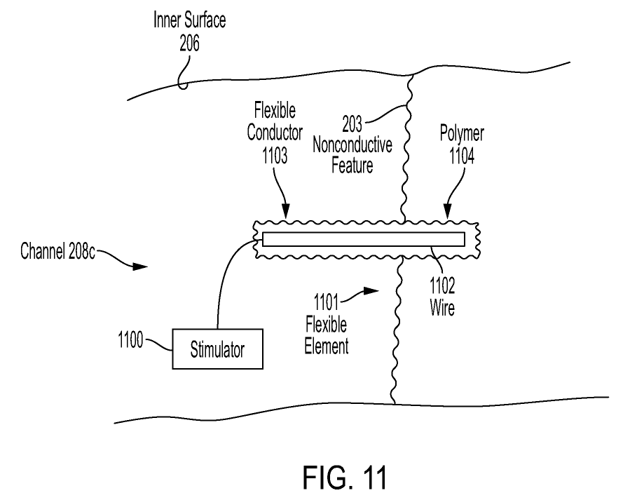

Similar to the flexible element illustrated in FIGS. 2 and 3, FIG. 11 illustrates a flexible element including a nonconductive feature and a flexible conductor. More specifically, FIG. 11 illustrates a flexible element 1101 including a nonconductive feature 203 and a flexible conductor 1103, where the flexible conductor includes a polymer 1104 and a wire 1102. The wire may be coupled to a stimulator 1100 in order to enable the flexible conductor to move long the channel 208c. FIG. 11 illustrates the polymer coupled along the entire length of the wire. However, the polymer may be coupled to one or more sections along the length of the wire. For example, the polymer in one (e.g., a first) section of the wire may not contact the polymer in another (e.g., a second) section of the wire. In one or more embodiments, the polymer may include electrically sensitive polymers or thermally sensitive polymers such that the polymer moves and/or changes shape due to electrical, magnetic or thermal stimulation by the stimulator. For example, a stimulator may apply an electrical charge to the wire and because the electrically sensitive polymer is couped to the wire, the electric charge is transferred to the electrically sensitive polymer such that the electrically sensitive polymer changes its shape and/or moves in a manner such that the wire, which includes the electrically sensitive polymer moves along the channel of the structure. Due to the polymer moving and/or changing shape, inertia is generated in at least the flexible conductor and causes the flexible conductor and thus, the flexible element to move along the channel. In one or more embodiments, the polymer may include a feature such that the polymer moves and/or changes shape. For example, the polymers' feature may include embedded metal particles, where a magnetic field generated by the simulator of other device may make the polymer move and/or change shape. In another example, the polymers' feature may include one or more fluid channels within the polymer such that the stimulator or other device such as a pump may be in fluid communication with the one or more fluid channels such that the fluid is forced into the one or more fluid channels to make the polymer move and/or change shape. FIG. 11 illustrates only one nonconductive feature however; a plurality of nonconductive features may be coupled to the flexible conductor.

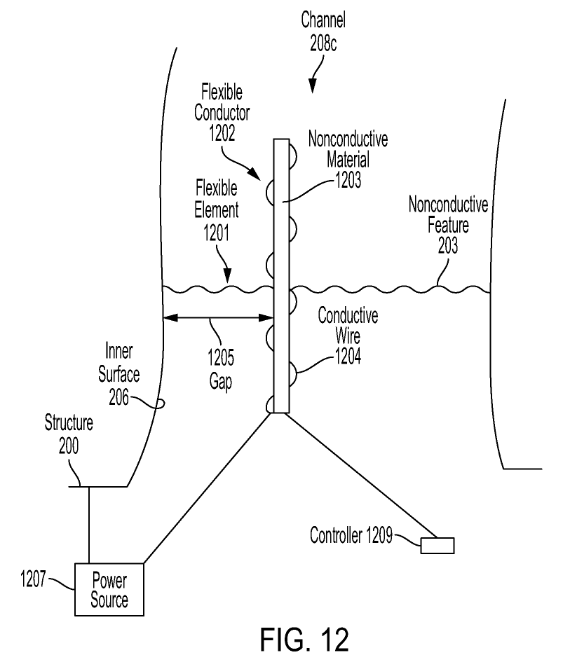

Similar to the flexible element illustrated in FIGS. 2 and 3, FIG. 12 illustrates a flexible element including a flexible conductor and a nonconductive feature. More specifically, FIG. 12 illustrates a flexible element 1201 including a nonconductive feature 203 and a flexible conductor 1202, where the flexible conductor includes a nonconductive material 1203 and a conductive wire 1204. Alternatively or additionally, a nonconductive film/coating may be on a portion of or all of the external surface of the conductive wire. A controller 1209 may be coupled to the nonconductive material to control and/or move the flexible element through the internal volume and/or channels of the structure. A power source 1207 may be coupled to the conductive wire and to the structure 200. The power source energizes the conductive wire and provides an electric potential difference between the conductive wire and the structure such that a voltage is applied across a gap (e.g., gap 1205). For example, to electropolish the internal/inner surface(s) of the structure, the power source creates a potential difference between the conductive wire and the structure such that the conductive wire functions as a cathode and the structure functions as an anode, thus applying a voltage across the gap. If the internal surface(s) of the structure is to be electroplated, then the power source creates a potential difference between the conductive wire and the structure such that the conductive wire functions as an anode and the structure functions as an cathode, thus applying a voltage across the gap. During an electropolishing process and an electroplating process, a processing media such as a fluid (e.g., a liquid, which may include a mixture of fluids) may be within the gap. FIG. 12 illustrates only one nonconductive feature however; a plurality of nonconductive features may be coupled to the flexible conductor.

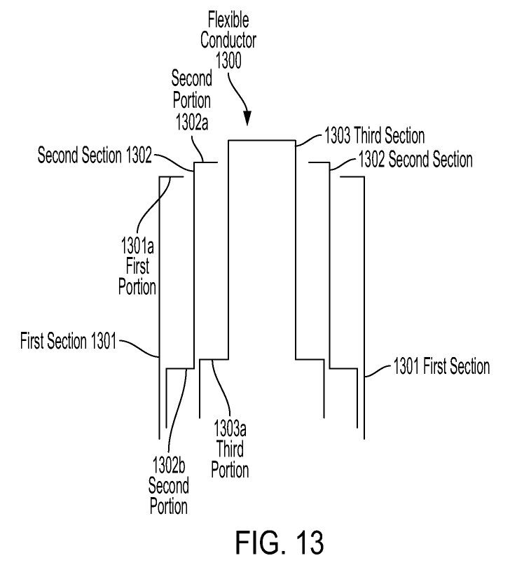

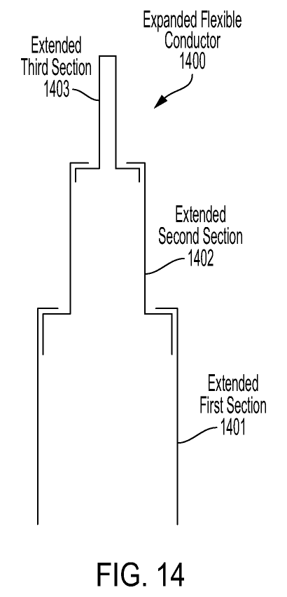

FIG. 13 illustrates an example of a flexible conductor usable in any of the apparatuses, systems and methods within this disclosure. The flexible conductor shown in FIG. 13 is in a compact position/state and capable of being extended. Flexible conductor 1300 includes a first section 1301, a second section 1302 and a third section 1303. The first section may include a first portion 1301a, the second section 1302a may include second portions 1302a,1302b and the third section may include a third portion 1303a. The flexible conductor may extend (see FIG. 14 for the flexible conductor being in an extended position/state), by applying a force to for example, the third section such that the third section moves (e.g., moves in an upward direction in FIG. 13) and the third portion contacts the second portion (e.g., second portion 1302a) and thus forces the second section to move (e.g., moves in an upward direction in FIG. 13) such that the second portion (e.g., second portion 1302b) contacts the first portion. In one or more embodiments, applying a force may include applying a fluid via a pump or other device/apparatus to the flexible conductor (e.g., the third section). In one or more embodiments, applying a force may include applying an electrical or magnetic force via an electrical or magnetic device/apparatus to the flexible conductor (e.g., the third section). In one or more embodiments, the third section of the flexible conductor may be fixed to an inner surface or an exterior surface of the structure. FIG. 13 illustrates the flexible conductor including three seconds however; the flexible conductor may include more or less sections than illustrated in FIG. 13.

FIG. 14 illustrates the sections of the flexible conductor of FIG. 13 in an extended state. FIG. 14 illustrates expanded flexible conductor 1400 including an extended third section 1403, an extended second section 1402 and an extended first section 1401, where the extended second and third sections have been extended such that the extended third section extends from and through the extended second section and the extended second section extends from and through the extended first section.

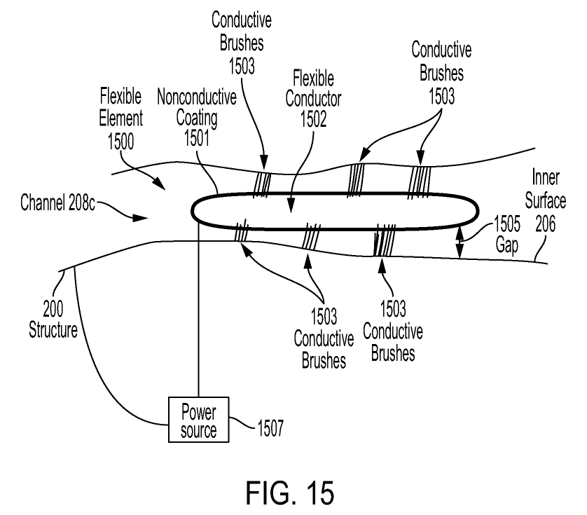

FIG. 15 illustrates an alternative embodiment of a flexible element. The flexible element differs from the illustrated flexible element of FIGS. 2 and 3 in that there are conductive brushes (i.e., electrically conductive brushes) coupled to the flexible conductor and the conductive brushes contact the inner surface of the structure. Thus, the embodiment of FIG. 15 allows for an electrical connection through the flexible conductor (e.g. a wire) to the conductive brushes by initiating current through the flexible conductor, thus charging the conductive brushes and because the conductive brushes are in contact/connection with the inner surfaces (e.g., channel inner surfaces) of the structure, electropolishing of the inner surfaces will be performed when a processing media such as a fluid (e.g., a liquid, which may include a mixture of fluids) is within a gap (e.g., gap 1505). Therefore, the conductive brushes function as a cathode, and the structure functions as an anode. FIG. 15 illustrates a flexible element 1500 including a nonconductive coating 1501, a flexible conductor 1502 and conductive brushes 1503. A power source 1507 may be coupled to the flexible conductor and the structure 200. The power source energizes the flexible element and the conductive brushes, and provides an electric potential difference between the flexible conductor and the structure such that a voltage is applied across a gap 1505 between the flexible conductor and the structure. The nonconductive coating (i.e., nonelectrically conductive coating) may be applied/coated on the flexible conductor. The conductive brushes may be coupled (e.g., embedded in) to the flexible conductor and contact the inner surface 206 of the structure. The conductive brushes may be spaced from one another at varying or fixed distances. The conductive brushes may include an electrically conductive material such as a metal or an alloy or graphite.

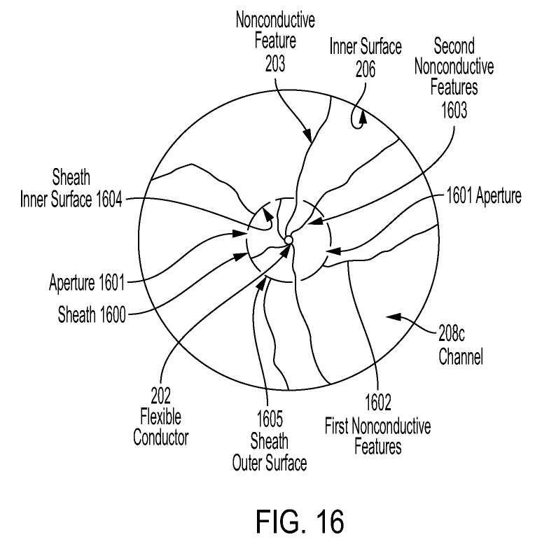

FIG. 16 enriches the electroplating/electrodepositing process illustrated in FIGS. 2 and 3 by including a sheath around the flexible conductor. In one or more embodiments, providing the sheath offset from the flexible element is also described by the process illustrated in FIG. 18. In addition to FIGS. 2 and 3, FIG. 16 includes a sheath placed around the flexible conductor and the nonconductive features are coupled to the sheath. As will be discussed below, the sheath may maintain proper electrolyte ion concentration along the length of the structures' surface being electrodeposited. More specifically, FIG. 16 illustrates a sheath 1600 placed around the flexible conductor 200 and within the channel 208c of the structure. The sheath may be placed around the flexible conductor before or after the flexible conductor is placed/inserted within the structure. The nonconductive features 203 may be coupled to the flexible conductor and contact the inner surface 206 of the structure. The sheath may include a nonconductive material and a plurality of apertures 1601. The sheath may include a first plurality of nonconductive features 1602 coupled to an external surface 1605 and along a length of the sheath to control the current density spacing between the flexible conductor and the structure and/or a second plurality of nonconductive features 1603 may be coupled to an internal surface of the sheath to maintain a desired gap between the flexible conductor and the sheath. The sheath may be offset from the flexible conductor (i.e., where the flexible conductor may function as an anode in the electroplating/electrodepositing process of FIG. 16) to allow flow of the electrolytes along its length and maintain a uniform current density. Furthermore, the apertures in the sheath may be along a length of the sheath to allow the processing media/fluid to flow and allow the movement of electrons and ions between the flexible conductor (i.e., anode) and the structure (i.e., cathode). The first plurality of nonconductive features may also contact the inner surface of the structure. The second plurality of nonconductive features may also couple to or contact the flexible conductor. The sheath may be oval shaped or circular shaped or triangular shape or any other geometric shape that maintains proper electrolyte ion concentration along the length of the structures' surface during the electroplating process.

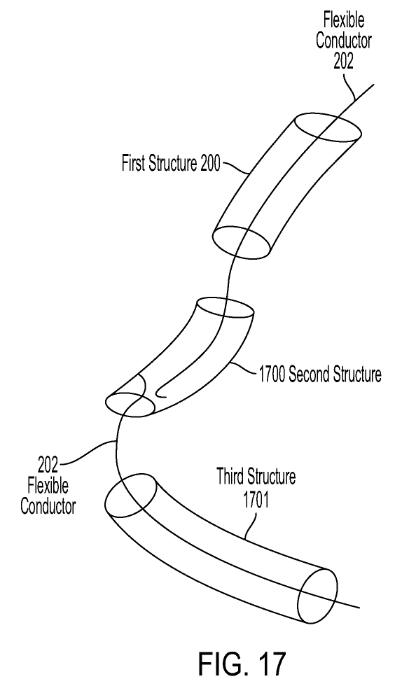

FIG. 17 illustrates one or more flexible elements placed/inserted within a plurality of structures. FIG. 17 illustrates a first structure 200, a second structure 1700, a third structure 1701 and two flexible conductors 202, where one of the flexible conductors may be within the first and second structures and the other flexible conductor may be within the second and third structures. Placing/inserting more than one (i.e., a plurality) flexible conductor in one or more structures may allow the electropolishing and electroplating processes to proceed even in cases where the channels are too convoluted (e.g., are not continuous and/or are discrete) for easy insertion of a single flexible conductor (e.g., an anode or a cathode). Also, having a plurality of flexible conductors (e.g., an anode or a cathode) placed/inserted within a plurality of structures at the same time allows for simultaneously electropolishing and/or electroplating surfaces of the plurality of structures, therefore saving time and thus costs of producing finished structures. The number of flexible conductors may be more or less than the number of flexible conductors shown in FIG. 17 and the number of structures may be more or less than the number of structures shown in FIG. 17. For example, there may be six flexible conductors placed/inserted within two structures.

FIG. 18 is a flowchart illustrating an example method 1800 of performing a finishing process on surfaces of a structure in accordance with the apparatuses, systems and processes/methods described herein. The example processes may be implemented on a 3D printed structure, for example, a structure printed using an example 3-D printer system, for example a 3-D printer system may be the PBF system 100 discussed in FIGS. 1A-1E.

At block 1801, the method may include inserting/placing a flexible element into an internal volume of a structure. The flexible element may include a flexible conductor and a nonconductive feature extending from the flexible conductor.

At block 1802, the method may include controlling the flexible element to move along a surface of the internal volume, such that the nonconductive feature forms a gap between the surface and the flexible conductor. The flexible conductor may include a wire. In one or more embodiments, controlling the flexible element may include moving the flexible element along one or more curved sections of the internal volume or channel of the structure. In one or more embodiments, controlling the flexible element may include manipulating the flexible element such that the flexible element moves within any channel and/or desired internal volume of the structure. In one or more embodiments, controlling the flexible element may include extending a plurality of connected sections of the flexible conductor along the surface of the structure. In one or more embodiments, controlling the flexible element may include stimulating a polymer of the nonconductive feature. In one or more embodiments, the flexible element may include a wire and a polymer and controlling the flexible element may include stimulating the flexible conductor.

At block 1803, the method may include energizing the flexible conductor such that a voltage is applied across the gap. Energizing the flexible conductor may include an electropolishing process or an electroplating process. The electropolishing and electroplating process may include a processing media such as a fluid (e.g., a liquid, which may include a mixture of fluids) inserted/flowed within at least the gap. For the electropolishing process, after placing/inserting the desired processing media/fluid in the structure, electropolishing the internal surface of the structure occurs by the way of energizing the flexible conductor, for example, by an application of electricity/voltage across the gap such that the structure functions as an anode and the flexible conductor functions as the cathode, and consequently material will be removed from the internal surface of the structure forming a smooth internal surface. For electroplating, after placing/inserting the desired processing media/fluid in the structure, electroplating the internal surface of the structure occurs by the way of energizing the flexible conductor, for example, by an application of electricity/voltage across the gap such that the flexible conductor functions as an anode and the structure functions as the cathode, and consequently material will be plated/deposited on the internal surface of the structure forming a smooth internal surface.

Block 1804 is optional and thus, optionally the method may include providing a sheath offset from the flexible element.

In any of the disclosure and embodiments, the flexible conductor may include an end portion that is rigid. For example, the flexible conductor may include a length portion and an end portion, where the end portion of the flexible conductor may have a greater rigidity (e.g., larger/higher modulus of elasticity) than the length portion of the flexible conductor. The flexible conductor having the end portion being rigid allows the end portion to be bendable at a distance from the very end of the flexible conductor. This may allow the flexible conductor to be steerable in channel bends that are larger in diameter than the diameter of the flexible conductor.

In any of the disclosure and embodiments, coupling and coupler may include mechanical, electrical, chemical or a combination thereof. For example, mechanical fasteners, electrical wireless or wire coupling and adhesives may include coupling or couplers.

The previous description is provided to enable any person skilled in the art to practice the various aspects described herein. Various modifications to these exemplary embodiments presented throughout this disclosure will be readily apparent to those skilled in the art, and the concepts disclosed herein may be applied to other techniques of finishing and printing structures. Thus, the claims are not intended to be limited to the exemplary embodiments presented throughout the disclosure, but are to be accorded the full scope consistent with the language of the claims. All structural and functional equivalents to the elements of the exemplary embodiments described throughout this disclosure that are known or later come to be known to those of ordinary skill in the art are intended to be encompassed by the claims. Moreover, nothing disclosed herein is intended to be dedicated to the public regardless of whether such disclosure is explicitly recited in the claims. No claim element is to be construed under the provisions of 35 U.S.C. §112(f), or analogous law in applicable jurisdictions, unless the element is expressly recited using the phrase “means for” or, in the case of a method claim, the element is recited using the phrase “step for.”

What is claimed is:

1. A method comprising:
inserting a flexible element into an internal volume of a structure, wherein the flexible element comprises a flexible conductor and a nonconductive feature extending from the flexible conductor;
controlling the flexible element to move along a surface of the internal volume, such that the nonconductive feature forms a gap between the surface and the flexible conductor; and
energizing the flexible conductor, such that a voltage is applied across the gap.

2. The method of claim 1, wherein the surface comprises one or more curved sections, and controlling the flexible element comprises moving the flexible element along the one or more curved sections.

3. The method of claim 1, wherein energizing the flexible conductor comprises an electropolishing process.

4. The method of claim 1, wherein energizing the flexible conductor comprises an electroplating process.

5. The method of claim 1, wherein the flexible conductor comprises a plurality of connected sections, and controlling the flexible element comprises extending the plurality of connected sections along the surface.

6. The method of claim 1, wherein the flexible conductor comprises a nonconductive material and an conductive wire, and the conductive wire is coupled to the nonconductive material.

7. The method of claim 1, wherein the nonconductive feature comprises a polymer, and controlling the flexible element comprises stimulating the polymer to move.

8. The method of claim 1, wherein the nonconductive feature comprises a plurality of features, and extending the nonconductive feature from the flexible conductor comprises stimulating the plurality of features.

9. The method of claim 1, wherein the nonconductive feature comprises bristles or springs or rings or a combination of bristles, springs and rings, such that the gap is maintained when controlling the flexible element.

10. The method of claim 1, wherein the flexible conductor comprises a wire, and controlling the flexible element comprises moving the wire along the surface.

11. The method of claim 1, wherein the flexible element comprises an end portion and a length portion, and providing the end portion with a greater rigidity than the length portion.

12. The method of claim 1, wherein the internal volume comprises a channel, and controlling the flexible element comprises manipulating the flexible element such that the flexible element moves within the channel.

13. The method of claim 12, wherein the channel comprises one or more curved sections, and controlling the flexible element comprises moving the flexible element along the one or more curved sections.

14. The method of claim 12, wherein the internal volume comprises additional channels, and controlling the flexible element comprises manipulating the flexible element to move within the channel and within any of the additional channels.

15. The method of claim 14, wherein one or more of the additional channels comprise one or more curved sections, and controlling the flexible element comprises moving the flexible element along the one or more curved sections.

16. The method of claim 1, further comprising providing a sheath offset from the flexible element, wherein the sheath comprises a plurality of apertures.

17. The method of claim 16, wherein the sheath comprises a nonconducting material, such that an electrical connection between the sheath and the structure is not formed.

18. The method of claim 16, wherein the nonconductive feature comprises a first set of features and a second set of features, wherein the first set of features extend from the flexible conductor, and providing the second set of features between the sheath and the surface.

19. The method of claim 1, wherein the flexible conductor comprises a wire and a polymer, and controlling the flexible element comprises stimulating the flexible conductor.

20. The method of claim 19, wherein stimulating the flexible conductor comprises providing one or more electrical signals to the flexible conductor.
